(19) United States
(12) Patent Application Publication
(10) Pub. No.: US 2015/0092682 A1
(43) Pub. Date: Apr. 2, 2015

(54) WIRELESS COMMUNICATIONS TERMINAL, WIRELESS COMMUNICATIONS SYSTEM, AND METHOD FOR TRANSMITTING AND RECEIVING DATA IN WIRELESS COMMUNICATIONS SYSTEM

(71) Applicant: SAMSUNG ELECTRO-MECHANICS CO., LTD., Suwon-Si (KR)

(72) Inventor: Chang Ju LEE, Suwon-Si (KR)

(73) Assignee: SAMSUNG ELECTRO-MECHANICS CO., LTD., Suwon-Si (KR)

(21) Appl. No.: 14/269,068

(22) Filed: May 2, 2014

(30) Foreign Application Priority Data
Sep. 27, 2013 (KR) 10-2013-0115516

(51) Int. Cl. H04W 72/02

(52) U.S. Cl. CPC H04W 72/02; H04W 88/06
USPC 370/329

(57) ABSTRACT

A wireless communications terminal may include: a wireless communications module configuring a network with at least one external terminal; a controlling unit receiving data communications information from the at least one external terminal to determine a data transfer ratio with the at least one external terminal; and a mobile communications module providing the data communications information and the data transfer ratio to a base station. The mobile communications module may transmit and receive data to and from the base station depending on the data transfer ratio and the wireless communications module may transmit and receive data to and from the at least one external terminal depending on the data transfer ratio.

### CROSS-REFERENCE TO RELATED APPLICATION

This application claims the benefit of Korean Patent Application No. 10-2013-0115516 filed on Sep. 27, 2013, with the Korean Intellectual Property Office, the disclosure of which is incorporated herein by reference.

### BACKGROUND

The present disclosure relates to a wireless communications terminal, a wireless communications system, and a method for transmitting and receiving data in a wireless communications system.

Cellular communications schemes may be generally classified as first-generation (1G) schemes, second-generation (2G) schemes, third-generation (3G) schemes and fourth-generation (4G) schemes. Among these cellular communications schemes, the 3G scheme widely used may be further classified as an asynchronous scheme representative of Wideband Code Division Multiple Access (WCDMA and a synchronous scheme representative of Code Division Multiple Access (CDMA). Meanwhile, the 4G scheme may be representative of Long Term Evloution (LTE), World Interoperability for Microwave Access (WiMax), and the like.

Recently, in order to increase data transmission rates, various technologies have been used. From among these, representative technology which has been prominent is Carrier Aggregation (CA) technology. CA technology allows two or more frequencies to be simultaneously received, such that it may increase data transmission and reception rates by around two times. However, in order to achieve this, a terminal should support communications in two or more frequencies and should be provided with a multiple antenna.

Meanwhile, in order to apply a multiple-input multiple-output (MIMO) scheme, another technology for improving data transmission rates, such an antenna should be additionally provided.

In terms of recently produced wireless communications terminals, mobile phones, as well as various terminals such as tablet PCs, notebook PCs, and like are often used by a single user and the use of cellular communications schemes is enabled with many such terminals, such that the transmission and reception of data have been enabled during user movement.

Patent Document 1, related to a communications system having an uplink space-time coding function implemented via adjusted mobile terminals, discloses a virtual MIMO transmission system using the mobile terminals in a group. However, unlike the present disclosure, contents of determining data transfer ratios to transmit and receive data to and from at least one external terminal and a base station are not disclosed therein.

### RELATED ART DOCUMENT

(Patent Document 1) Korean Patent Publication No. 10-1033104

### SUMMARY

An aspect of the present disclosure may provide a wireless communications terminal, a wireless communications system, and a method for transmitting and receiving data in a wireless communications system, capable of transmitting and receiving data to and from a base station and at least one external terminal, according to a data transfer ratio, after configuring a network with the at least one external terminal and determining the data transfer ratio using data communications information received from the at least one external terminal.

According to an aspect of the present disclosure, a wireless communications terminal may include: a wireless communications module configuring a network with at least one external terminal; a controlling unit receiving data communications information from the at least one external terminal to determine a data transfer ratio with the at least one external terminal; and a mobile communications module providing the data communications information and the data transfer ratio to a base station, wherein the mobile communications module transmits and receives data to and from the base station depending on the data transfer ratio and the wireless communications module transmits and receives data to and from the at least one external terminal depending on the data transfer ratio.

The wireless communications module may include at least one of a Wi-Fi module configuring the network with the at least one external terminal via Wi-Fi and a Bluetooth module configuring the network with the at least one external terminal via Bluetooth.

The wireless communications module may configure the network with the at least one external terminal via at least one of Wi-Fi and Bluetooth.

The controlling unit may confirm whether or not the at least one external terminal is able to configure the network by transmitting a ready confirmation signal to the at least one external terminal via the wireless communications module.

The controlling unit may check a data transmission and reception state with at least one of the base station and the at least one external terminal and adjust the data transfer ratio depending on the data transmission and reception state.

The data communications information may include an Internet Protocol (IP) address, an available frequency, and an available data transmitting and receiving ratio of the at least one external terminal configuring the network.

According to another aspect of the present disclosure, a wireless communications system may include: a main terminal; and at least one sub-terminal, wherein the main terminal configures a network with the at least one sub-terminal, the at least one sub-terminal provides data communications information to the main terminal, and the main terminal determines a data transfer ratio with the at least one sub-terminal depending on the data communications information and transmits and receives data to and from a base station and the at least one sub-terminal depending on the data transfer ratio.

The main terminal may configure the network with the at least one sub-terminal via at least one of Wi-Fi and Bluetooth.

The main terminal may transmit a ready confirmation signal to the at least one sub-terminal so as to confirm whether or not the at least one sub-terminal is able to configure the network.

The main terminal may check a data transmission and reception state with at least one of the base station and the at least one sub-terminal and adjust the data transfer ratio depending on the data transmission and reception state.

The data communications information may include an Internet Protocol (IP) address, an available frequency, and an available data transmitting and receiving ratio of the at least one sub-terminal configuring the network with the main terminal.

The main terminal may provide the data communications information and the data transfer ratio to the base station, the at least one sub-terminal may transmit and receive data to and from the base station depending on the data transfer ratio, and the main terminal may transmit and receive data to and from at least one of the base station and the at least one sub-terminal depending on the data transfer ratio.

According to another aspect of the present disclosure, a method for transmitting and receiving data in a wireless communications system may include: configuring a network with at least one external terminal; receiving data communications information from the at least one external terminal to determine a data transfer ratio; providing the data communications information and the data transfer ratio to a base station; and transmitting and receiving data to and from at least one of the base station and the at least one external terminal depending on the data transfer ratio.

The method may further include: transmitting a ready confirmation signal to the at least one external terminal; and confirming whether the at least one external terminal is able to configure the network.

In the configuring of the network, the network may be configured with the at least one external terminal via at least one of Wi-Fi and Bluetooth.

The transmitting and receiving of the data may include: transmitting and receiving, by the at least one external terminal, data, to and from the base station depending on the data transfer ratio; and receiving, by the at least one external terminal, the data received from the base station depending on the data transfer ratio.

The data communications information may include an Internet Protocol (IP) address, an available frequency, and an available data transmitting and receiving ratio of the at least one external terminal.

The method may further include: checking a data transmission and reception state with at least one of the base station and the at least one external terminal; adjusting the data transfer ratio depending on the data transmission and reception state; and providing the adjusted data transfer ratio to at least one of the base station and the at least one external terminal.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a block diagram of a wireless communications terminal according to an exemplary embodiment of the present disclosure;

FIG. 2 is a block diagram showing an example of a wireless communications module shown in FIG. 1;

FIG. 3 is a diagram showing a wireless communications system according to an exemplary embodiment of the present disclosure;

FIG. 4 is a diagram for describing a method for transmitting and receiving data in the wireless communications system according to an exemplary embodiment of the present disclosure;

FIG. 5 is a diagram showing data communications information according to an exemplary embodiment of the present disclosure;

FIG. 6 is a flow chart showing a method for transmitting and receiving data in a wireless communications system according to an exemplary embodiment of the present disclosure; and

FIG. 7 is a flow chart showing a method for transmitting and receiving data in a wireless communications system according to another exemplary embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. Throughout the drawings, the same or like reference numerals will be used to designate the same or like elements.

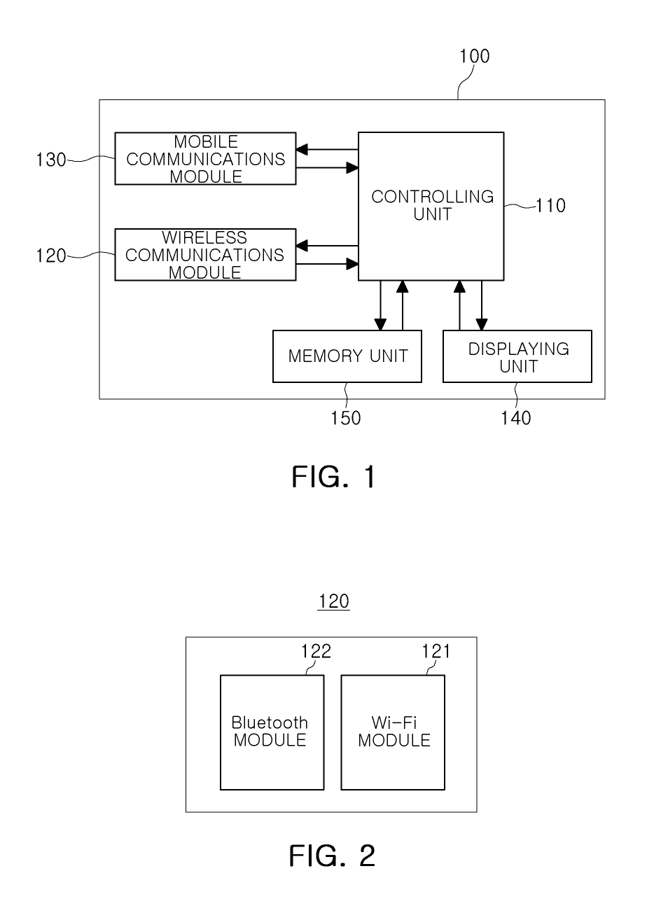

FIG. 1 is a block diagram of a wireless communications terminal 100 according to an exemplary embodiment of the present disclosure.

Referring to FIG. 1, the wireless communications terminal 100 according to an exemplary embodiment of the present disclosure may include a wireless communications module 120 configuring a network with at least one external terminal 200, a controlling unit 110 receiving data communications information from the at least one external terminal 200 to determine a data transfer ratio with the at least one external terminal 200, and a mobile communications module 130 providing the data communications information and the data transfer ratio to a base station 300.

In addition, the wireless communications terminal 100 may include a display unit 140 displaying a current data transmission and reception state and further include a memory unit 150 storing the data communications information and the data transfer ratio therein.

In this case, the mobile communications module 130 may transmit and receive data to and from the base station 300 according to the data transfer ratio and the wireless communications module 120 may transmit and receive data to and from the at least one external terminal 200 according to the data transfer ratio.

The wireless communications terminal 100 according to an exemplary embodiment of the present disclosure will be described in more detail.

FIG. 2 is a block diagram showing an example of the wireless communications module 120 shown in FIG. 1.

Referring to FIGS. 1 and 2, the wireless communications module 120 may include at least one of a Wi-Fi module 121 configuring the network with the at least one external terminal 200 via Wi-Fi and a Bluetooth module 122 configuring the network with the at least one external terminal 200 via Bluetooth.

That is, the wireless communications module 120 may include at least one of the Wi-Fi module 121 and the Bluetooth module 122 and may configure the network with the at least one external terminal 200 using at least one of the Wi-Fi module 121 and the Bluetooth module 122.

Meanwhile, the controlling unit 110 may determine the data transfer ratio using the data communications information and may determine a data transmitting and receiving ratio with each of the base station 300 and the at least one external terminal 200 using the data transfer ratio.

In this case, the data communications information may include an Internet Protocol (IP) address, an available frequency, and an available data transmitting and receiving ratio of the at least one external terminal 200 constituting the network. A description thereof will be provided below.

In addition, the controlling unit 110 may transmit a ready confirmation signal to the at least one external terminal 200 via the wireless communications module 120 so as to configure the network with the at least one external terminal 200. Thereby, the controlling unit 110 may confirm whether or not the at least one external terminal 200 is able to configure the network.

After the at least one external terminal 200 receives the ready confirmation signal via the wireless communications module 120, it may transmit a ready signal to the wireless communications module 120 when a ready operation capable of configuring the network is completed.

After the controlling unit 110 receiving the ready signal via the wireless communications signal 120 confirms whether or not the network is able to be configured, it may configure the network with the at least one external terminal 200 using at least one scheme of the Wi-Fi and the Bluetooth. In this case, as a method for configuring the network, various local area communications schemes may be used and the method for configuring the network is not limited to such as Wi-Fi and Bluetooth schemes.

In addition, after the controlling unit 110 determines the data transfer ratio, it may provide the data communications information and the data transfer ratio to the base station 300.

In this case, the base station 300 may register the at least one external terminal 200 providing the data communications information with reference to the data transfer ratio. The base station 300 may transmit and receive data to and from the at least one registered external terminal 200 according to the data transfer ratio and the at least one external terminal 200 may provide the data received from the base station 300 to the wireless communications terminal 100 according to the data transfer ratio. Alternatively, the wireless communications terminal 100 may transmit and receive the data to and from the at least one external terminal 200 according to the data transfer ratio.

That is, the wireless communications terminal 100 according to an exemplary embodiment of the present disclosure may transmit and receive data to and from the base station 300 according to the data transfer ratio and may transmit and receive data via the at least one external terminal 200 according to the data transfer ratio.

Meanwhile, the controlling unit 100 may check a data transmission and reception state thereof with at least one of the base station 300 and the at least one external terminal 200 and may adjust the data transfer ratio according to an abnormal state when the data transmission and reception state is abnormal.

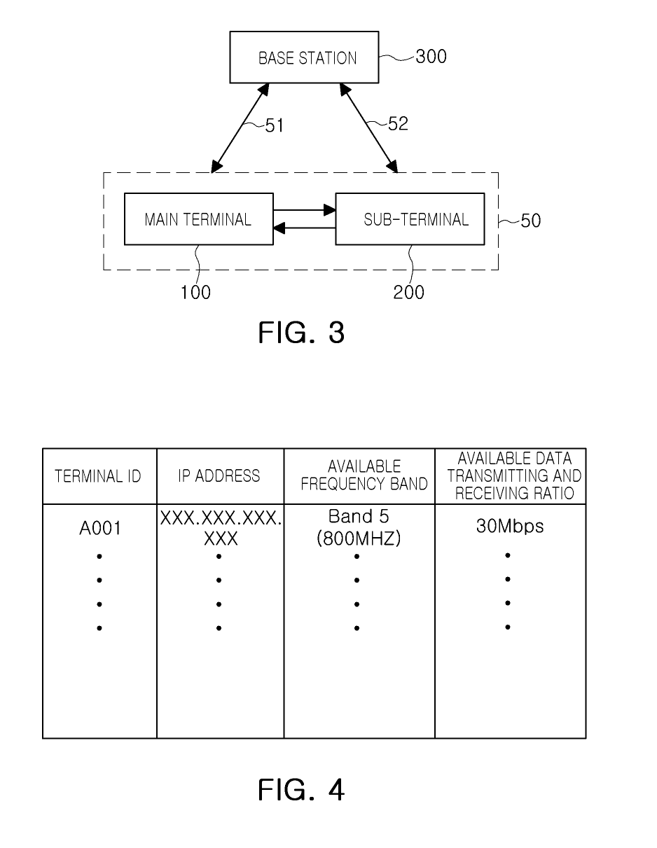

Hereinafter, a wireless communications system according to an exemplary embodiment of the present disclosure will be described with reference to FIGS. 3 through 5.

FIG. 3 is a diagram showing a wireless communications system according to an exemplary embodiment of the present disclosure.

FIG. 4 is a diagram showing data communications information according to an exemplary embodiment of the present disclosure.

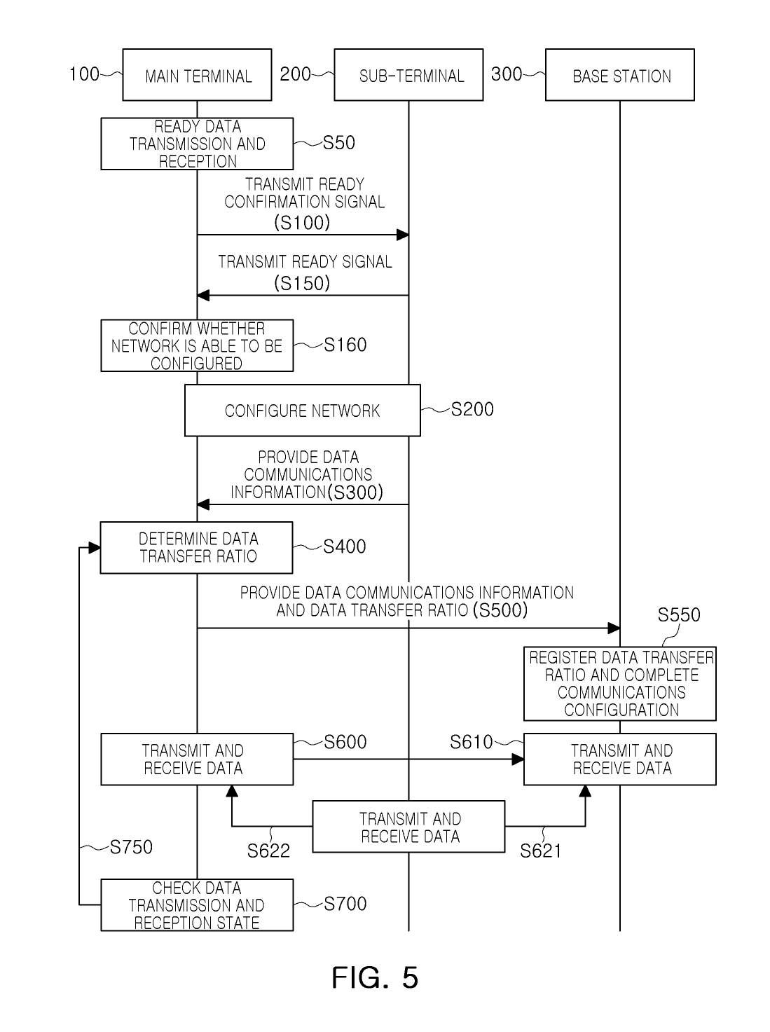

FIG. 5 is a diagram for describing a method for transmitting and receiving data in the wireless communications system according to an exemplary embodiment of the present disclosure.

In this case, the wireless communications terminal 100 may be a main terminal and the at least one external terminal 200 may be at least one sub-terminal.

FIG. 3 shows a schematic connection relationship of the wireless communications system. That is, the main terminal 100 may configure a network 50 with the at least one sub-terminal 200. In this case, a method for configuring the network 50 is the same as that described above and as long as a communications network may be formed in a local area, it may be used without limitation.

After the main terminal 100 forms the network 50 with the at least one sub-terminal 200, it may provide the data communications information and the data transfer ratio to the base station 300.

Depending on the data communications information and the data transfer ratio, the base station 300 may register a data transmitting and receiving ratio and a connection relationship with each of the main terminal 100 and the at least one sub-terminal 200. That is, the base station 300 may directly transmit and receive data to and from the main terminal 100 depending on the data transfer ratio with the main terminal 100 (51) and may indirectly transmit and receive data to and from the main terminal 100 via the at least one sub-terminal 200.

A description thereof will be provided in detail with reference to FIG. 5.

Referring to FIG. 5, the main terminal 100 may ready a data transmitting and receiving operation (S50). After the ready for the data transmitting and receiving operation S50 is completed, the main terminal 100 may transmit a ready confirmation signal to at least one sub-terminal 200 so as to form a network (S100). Next, in a case in which the at least one sub-terminal 200 is ready to form the network is completed, the at least one sub-terminal 200 may transmit a ready signal to the main terminal 100 (S150).

The main terminal 100 that has received the ready signal may re-confirm whether or not it is able to configure the network with the at least one sub-terminal 200 (S160) and when the network is able to be configured, the main terminal 100 may configure the network using at least one of Bluetooth and Wi-Fi, as an example (S200). Next, the at least one sub-terminal 200 may provide data communications information. In this case, referring to FIG. 4, the data communications information may include an IP address, an available frequency and an available data transmitting and receiving ratio of the at least one sub-terminal.

A process (S400) of determining the data transfer ratio will be described with reference to FIG. 5, as an example. The main terminal 100 may determine the data transfer ratio according to a kind of communications network to which it is currently connected. Here, a case in which the main terminal 100 is currently connected at 3 mbps via the Bluetooth is illustrated.

Meanwhile, an effect such as Multiple-Input Multiple-Output (MIMO) may be expected when the available frequency in the data communications information received by the main terminal 100 is equal to a current available frequency of the main terminal 100 and an effect such as Carrier Aggregation (CA) may be expected when the available frequency in the data communications information received by the main terminal 100 is different from the current available frequency of the main terminal 100.

An available data transfer ratio of the main terminal 100 configuring the network may be determined according to a communications network between the main terminal 100 and the at least one sub-terminal 200 via the wireless communications module 120 or a cellular network between the main terminal 100 and the base station 300 via the mobile communications module 130. That is, the data transfer ratio may be determined by the communications network having a low data transfer ratio among the two communications networks. This is the reason that only in a case in which the data transfer ratio is determined by the communications network having a low data transfer ratio, the data transfer ratio may be the same as a transfer rate of data provided to the base station 300 or the at least sub-terminal 200 by the main terminal 100.

More specifically, since the main terminal 100 and the at the least one sub-terminal 200 configuring the communications network are connected at 3 Mbps, and the main terminal 100 and the base station 300 are connected to each other at 30 Mbps, an available transfer rate of the main terminal 100 is 3 Mbps and the data transfer ratio may be 30 Mbps:3 Mbps, that is, 10:1.

Once the data transfer ratio is determined as described above, the main terminal 100 may provide the determined data transfer ratio and the data communications information to the base station 300 (S500). In this case, the base station 300 may complete a communications configuration with the at least one sub-terminal 200 and the main terminal 100 depending on the data transfer ratio (S550).

Next, the base station 300 may transmit and receive data to and from the main terminal 100 depending on the predetermined data transfer ratio (S600 and S610). In addition, the base station 300 may transmit and receive data to and from the main terminal 100 (S622) via a data transmission and reception operation with the at least one sub-terminal 200 (S621).

Meanwhile, the controlling unit 110 of the main terminal 100 may check the data transmission and reception state. If the data transmission and reception state is abnormal, the main terminal 100 may re-determine the data transfer ratio (S400).

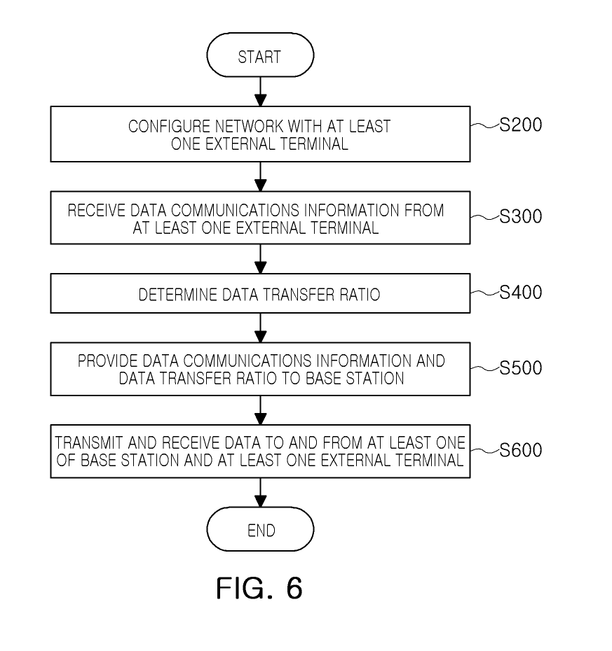

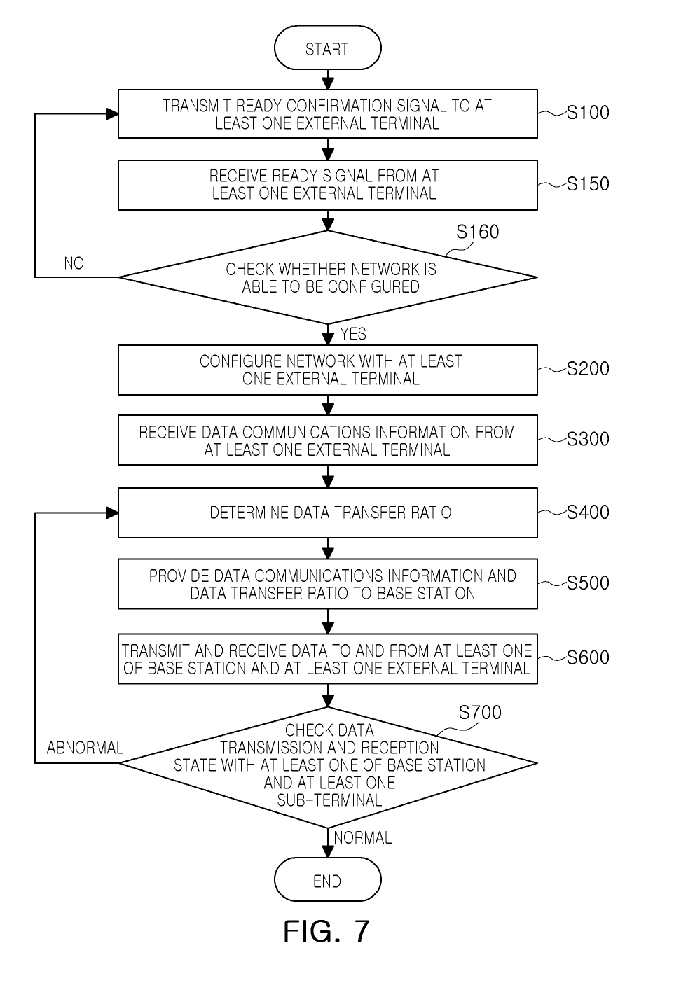

Next, a method for transmitting and receiving data in a wireless communications system according to an exemplary embodiment of the present disclosure will be described with reference to FIGS. 6 and 7.

FIG. 6 is a flow chart showing a method for transmitting and receiving data in a wireless communications system according to an exemplary embodiment of the present disclosure.

FIG. 7 is a flow chart showing a method for transmitting and receiving data in a wireless communications system according to another exemplary embodiment of the present disclosure.

Referring to FIG. 6, a method for transmitting and receiving data in a wireless communications system according to an exemplary embodiment of the present disclosure may include configuring a network with at least one external terminal 200 (S200), receiving data communications information from the at least one external terminal 200 to determine a data transfer ratio (S300), providing the data communications information and the data transfer ratio to the base station 300 (S400), and transmitting and receiving data to and from at least one of the base station 300 and the at least one external terminal 200 depending on the data transfer ratio (S600).

A description thereof will be provided in detail with reference to FIG. 7. Referring to FIG. 7, the method for transmitting and receiving data of the wireless communications system according to an exemplary embodiment of the present disclosure may further include transmitting a ready confirmation signal to the at least one external terminal 200 (S100) and confirming whether or not the at least one external terminal 200 is able to configure a network (S160).

In this case, if the at least one external terminal 200 is unable to configure the network, the process of the method may return to the transmitting of the ready confirmation signal by the main terminal 100, to the at least one external terminal 200.

In addition, the method for transmitting and receiving data in the wireless communications system according to an exemplary embodiment of the present disclosure may further include checking a data transmission and reception state with at least one of the base station and the at least one sub-terminal (S700) and adjusting the data transfer ratio depending on the data transmission and reception state (S400).

In addition, the method for transmitting and receiving data of the wireless communications system according to an exemplary embodiment of the present disclosure may include retransmitting, by the main terminal 100, the adjusted data transfer ratio to at least one of the base station 300 and the at least one sub-terminal 200.

As set forth above, according to exemplary embodiments of the present disclosure, in the wireless communications terminal, the wireless communications system, and the method for transmitting and receiving data in the wireless communications system, data is transmitted and received to and from the base station and the at least one sub-terminal by forming a network with at least one external terminal and determining a data transfer ratio with the at least one external terminal, such that a single user may interactively use the wireless communications terminal in the cellular communications scheme to configure Carrier Aggregation (CA), Multiple-Input Multiple-Output (MIMO), or the like. In addition, the user may transmit and receive data at rapid speed without implementation of the CA or the MIMO within one wireless communications terminal.

While exemplary embodiments have been shown and described above, it will be apparent to those skilled in the art that modifications and variations could be made without departing from the spirit and scope of the present disclosure as defined by the appended claims.

What is claimed is:

1. A wireless communications terminal comprising:
a wireless communications module configuring a network with at least one external terminal;
a controlling unit receiving data communications information from the at least one external terminal to determine a data transfer ratio with the at least one external terminal; and
a mobile communications module providing the data communications information and the data transfer ratio to a base station,
wherein the mobile communications module transmits and receives data to and from the base station depending on the data transfer ratio and the wireless communications module transmits and receives data to and from the at least one external terminal depending on the data transfer ratio.

2. The wireless communications terminal of claim 1, wherein the wireless communications module includes at least one of a Wi-Fi module configuring the network with the at least one external terminal via Wi-Fi and a Bluetooth module configuring the network with the at least one external terminal via Bluetooth.

3. The wireless communications terminal of claim 1, wherein the wireless communications module configures the network with the at least one external terminal via at least one of Wi-Fi and Bluetooth.

4. The wireless communications terminal of claim 1, wherein the controlling unit confirms whether or not the at least one external terminal is able to configure the network by transmitting a ready confirmation signal to the at least one external terminal via the wireless communications module.

5. The wireless communications terminal of claim 1, wherein the controlling unit checks a data transmission and reception state with at least one of the base station and the at least one external terminal and adjusts the data transfer ratio depending on the data transmission and reception state.

6. The wireless communications terminal of claim 1, wherein the data communications information includes an Internet Protocol (IP) address, an available frequency, and an available data transmitting and receiving ratio of the at least one external terminal configuring the network.

7. A wireless communications system comprising:
a main terminal; and
at least one sub-terminal,
wherein the main terminal configures a network with the at least one sub-terminal,
the at least one sub-terminal provides data communications information to the main terminal, and
the main terminal determines a data transfer ratio with the at least one sub-terminal depending on the data communications information and transmits and receives data to and from a base station and the at least one sub-terminal depending on the data transfer ratio.

8. The wireless communications system of claim 7, wherein the main terminal configures the network with the at least one sub-terminal via at least one of Wi-Fi and Bluetooth.

9. The wireless communications system of claim 7, wherein the main terminal transmits a ready confirmation signal to the at least one sub-terminal so as to confirm whether or not the at least one sub-terminal is able to configure the network.

10. The wireless communications system of claim 7, wherein the main terminal checks a data transmission and reception state with at least one of the base station and the at least one sub-terminal and adjusts the data transfer ratio depending on the data transmission and reception state.

11. The wireless communications system of claim 7, wherein the data communications information includes an Internet Protocol (IP) address, an available frequency, and an available data transmitting and receiving ratio of the at least one sub-terminal configuring the network with the main terminal.

12. The wireless communications system of claim 7, wherein the main terminal provides the data communications information and the data transfer ratio to the base station, the at least one sub-terminal transmits and receives data to and from the base station depending on the data transfer ratio, and the main terminal transmits and receives data to and from at least one of the base station and the at least one sub-terminal depending on the data transfer ratio.

13. A method for transmitting and receiving data in a wireless communications system, the method comprising:
configuring a network with at least one external terminal;
receiving data communications information from the at least one external terminal to determine a data transfer ratio;
providing the data communications information and the data transfer ratio to a base station; and
transmitting and receiving data to and from at least one of the base station and the at least one external terminal depending on the data transfer ratio.

14. The method of claim 13, further comprising:
transmitting a ready confirmation signal to the at least one external terminal; and
confirming whether the at least one external terminal is able to configure the network.

15. The method of claim 13, wherein in the configuring of the network, the network is configured with the at least one external terminal via at least one of Wi-Fi and Bluetooth.

16. The method of claim 13, wherein the transmitting and receiving of the data includes:
transmitting and receiving, by the at least one external terminal, data to and from the base station depending on the data transfer ratio; and
receiving, by the at least one external terminal, the data received from the base station depending on the data transfer ratio.

17. The method of claim 13, wherein the data communications information includes an Internet Protocol (IP) address, an available frequency, and an available data transmitting and receiving ratio of the at least one external terminal.

18. The method of claim 13, further comprising:
checking a data transmission and reception state with at least one of the base station and the at least one external terminal;
adjusting the data transfer ratio depending on the data transmission and reception state; and
providing the adjusted data transfer ratio to at least one of the base station and the at least one external terminal.
